(19) United States
(12) Patent Application Publication
(10) Pub. No.: US 2004/0201698 A1
(43) Pub. Date: Oct. 14, 2004

(54) Camera-based system for capturing images of a target area

(76) Inventors: Vaughn E. Keenan, Calgary (CA); Wallace I. Kroeker, Calgary (CA); Mark A. Fletcher, Calgary (CA); Shawn W. Duce, Calgary (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/876,230

(22) Filed: Jun. 8, 2001

(51) Int. Cl. H04N 5/225

(52) U.S. Cl. 348/207.99

(57) ABSTRACT

A camera-based system for capturing images of a target area includes a boom assembly adapted to extend outwardly from a generally vertical surface. At least one digital camera is mounted on the boom assembly at a location spaced from the surface. The at least one digital camera is oriented so that the field of view thereof encompasses a target area on the surface. A controller is in communication with the at least one digital camera. The controller conditions the at least one digital camera to acquire an image of the target area. The image acquired by the at least one digital camera is conveyed to the controller and is processed to form a digital image of the target area. The digital image is published automatically to allow the digital image to be accessed by a user through a web client application.

### FIELD OF THE INVENTION

The present invention relates generally to image acquisition and in particular to a camera-based system for capturing images of a target area. The present invention also relates to a camera-based system for automatically publishing digital images of a target area thereby allowing the images to be accessed through a web client application such as an Internet browser.

### BACKGROUND OF THE INVENTION

During meetings, boards such as whiteboards, chalkboards, flipchart pads, and tackboards are commonly used to record information. In collaborative environments, several users may view, supplement and/or edit information recorded on the boards. In situations where the boards are passive, it is difficult and cumbersome to transfer information recorded on the boards to other media that facilitates storage and retrieval of the recorded information.

To deal with the above problem, automated capture systems to capture information recorded on a board have been considered. These automated capture systems include for example, automated copyboards, flipchart scanners, active or specialized pen systems based on acoustic time-of-flight, electromagnetic detection, or laser scanning as well as analog resistive whiteboards. Although these automated capture systems have permitted information recorded on a board to be transferred to other media types, these automated capture systems suffer disadvantages.

For example, automated copyboards and flipchart scanners rely on moving parts that require significant power. This of course reduces long term reliability and creates noise in the work environment. Also, automated copyboards and flipchart scanners are restricted to dry-erase ink. Furthermore, the electronic capture, image processing and distribution capabilities of automated copyboards and flipchart scanners are generally limited to the creation of bitmap (.bmp) files that are communicated to a personal computer over an RS-232 interface.

Acoustic time-of-flight and electromagnetic pen systems make use of battery powered dry-erase pen jackets to record information on a board. As a result, these dry-erase pen jackets require periodic maintenance (i.e. battery replacement) and are prone to damage if mishandled. Also, in order to capture information recorded on a board, acoustic time-of-flight and electromagnetic pen systems must be fully operational prior to use of the jacketed pens.

In the case of acoustic time-of-flight pen systems, during writing or drawing on a board, users must apply enough pressure using the jacketed pens and keep the jacketed pens relatively perpendicular to the board surface to ensure the drawing or writing is captured. Even experienced users fail to maintain the necessary pressure and orientation with every pen stroke, making acoustic time-of-flight pen systems prone to information loss. In addition, users must also avoid blocking the signal path with an object or body part when recording information on the board surface. Furthermore, ambient acoustical noise from environment HVAC systems and/or other transient acoustical events may interfere with the proper operation of acoustic time-of-flight pen systems.

Laser scanning detection pen systems make use of bar-coded dry-erase pens and erasers to record information on a board. These dry-erase pens and erasers are typically only available from the system suppliers, which often leads to increased costs. Also, in order to capture information recorded on a board, laser scanning detection pen systems must be fully operational before the information is recorded. Furthermore, the mechanical tolerances that must be maintained to enable laser scanning detection pen systems to determine when a pen or eraser is in contact with the board and when it is not, so that natural writing can be captured reliably, are very onerous. This problem increases in severity as the size of the board increases. As a result, periodic re-alignment of systems of this nature are often required to maintain the mechanical tolerances.

Analog resistive whiteboards also must be fully operational before information is recorded on the board using dry-erase ink pens if the information is to be captured. Also, users must apply enough pressure to the board using the pens to ensure pen strokes are detected and captured. Even experienced users fail to apply sufficient pressure to the board during writing and as a result, these systems can be prone to information loss. In addition, analog resistive whiteboards require a supplementary system to keep track of the type of tool being used to record information on the board. These supplementary system require users to be trained, leading inevitably to user errors, which translate into information capture errors.

In addition to the automated capture systems described above, camera-based systems to capture information recorded on a board have been considered. For example, U.S. Pat. No. 5,529,290 to Saund discloses a device for transcribing markings drawn on a whiteboard or blackboard into an electronic form using a camera-based board scanner. The scanner is in the form of a video camera mounted on a computer controlled pan/tilt head suspended from the ceiling or mounted to one side of the board. The camera is directed successively at small regions (tiles) of the board and snapshots of the tiles are captured until a complete image of the entire board is obtained.

U.S. Pat. No. 5,581,637 to Cass et al discloses a device for transcribing markings drawn on a whiteboard or blackboard into an electronic form using a camera-based board scanner. A registration light pattern is projected onto the surface of the board to be imaged. The projected pattern is selected to suit the properties of the camera and the imaging environment. The camera is directed successively at tiles of the board and snapshots of the tiles are captured. The pattern markings are processed using perspective transformations to determine the overlap properties of the tiles and the distortion of each tile. The resulting data is used to combine the tiles to produce an undistorted image of the entire board.

Unfortunately, the use of a pan-tilt-zoom camera makes the tile image capture process slow. Also, the position of the camera in these systems requires the user to move to get out of the field of view of the camera as the succession of tile images are captured. In addition, since the pan-tilt-zoom camera is suspended from the ceiling or mounted to the side of the board, a unique set of perspective correction parameters obtained through a post installation calibration system is required for each captured tile. As will be appreciated improvements to systems for capturing information recorded on a board are desired.

It is therefore an object of the present invention to provide a novel camera-based system for capturing images of a target area.

### SUMMARY OF THE INVENTION

According to one aspect of the present invention there is provided a camera-based system for capturing images of a target area comprising:

a generally horizontally extending boom assembly, said boom assembly being positioned above a target area;

at least one digital camera mounted on said boom assembly at a location spaced from the plane of said target area, said at least one digital camera being oriented so that the field of view thereof encompasses said target area; and

a controller in communication with said at least one digital camera, said controller receiving image data from said at least one digital camera and processing said image data to form a digital image of said target area.

According to another aspect of the present invention there is provided a camera-based system for capturing images of a target area comprising:

a boom assembly adapted to extend outwardly from a generally vertical surface;

at least one digital camera mounted on said boom assembly at a location spaced from said surface, said at least one digital camera being oriented so that the field of view thereof encompasses said target area; and

a controller in communication with said at least one digital camera, said controller conditioning said at least one digital camera to acquire an image of said target area, said image acquired by said at least one digital camera being conveyed to said controller and processed to form a digital image of said target area, said digital image being accessible to a user through a web client application.

According to yet another aspect of the present invention there is provided a camera-based system for capturing images of a target surface comprising:

a board mounted on a wall and having a surface on which information is to be recorded;

a boom assembly positioned above said board and extending outwardly from said wall in a generally horizontal disposition;

at least one digital camera mounted on said boom assembly at a location spaced from said wall, said at least one digital camera being oriented so that the field of view thereof encompasses a target area of said surface; and

a controller in communication with said at least one digital camera and having Internet server capabilities, said controller being responsive to user input and conditioning said at least one digital camera to acquire an image of said target area, said image acquired by said at least one digital camera being conveyed to said controller and processed to form an electronic image of said target area, said electronic image being published automatically to allow said electronic image to be accessed by a user through a web client application.

According to still yet another aspect of the present invention there is provided an image publication and distribution method comprising the steps of:

acquiring an image of a target area that includes information recorded on said target area;

processing said image to form an electronic ink on white image of the information recorded on said target area; and

automatically publishing said electronic image to allow said electronic image to be accessed by a user through a web client application.

The present invention provides advantages in that since the boom assembly is positioned above the target area and is short, a user recording information on the target area typically remains outside of the field of view of the at least one digital camera. Thus, images of the target area can be acquired without requiring the user to move away from the target area during image capture. As a result, complete unobscured images of the target area can be captured more quickly than has been achievable in the past and in a user friendly manner. In addition, no special tools are required to mark the target area. Depending on the nature of the target area, a user may use any color and/or thickness of ink, chalk, dry-erase marker, flipchart marker or erasing tool, including fingers or whiteout. Furthermore, the controller does not need to be operational when information is being recorded on the target area. The controller can be activated after the target area has been marked.

### BRIEF DESCRIPTION OF THE DRAWINGS

Embodiments of the present invention will now be described more fully with reference to the accompanying drawings in which:

FIG. 1 is an isometric view of a camera-based system for capturing images of a target area in accordance with the present invention;

FIG. 2 is an exploded isometric view of a boom assembly forming part of the camera-based system illustrated in FIG. 1;

FIG. 3 is a block diagram of a digital camera forming part of the boom assembly illustrated in FIG. 2;

FIG. 4a is a front elevational view of a controller forming part of the camera-based system illustrated in FIG. 1;

FIG. 4b is an isometric view of the controller illustrated in FIG. 4a;

FIG. 5 is a block diagram of the controller internal circuitry;

FIGS. 6a and 6b are screen displays of a personal computer (PC) based Internet browser accessing digital images captured and published by the camera-based system illustrated in FIG. 1;

FIGS. 7a and 7b are screen displays showing controller configuration options that are accessible through the PC-based Internet browser;

FIG. 8 is a side elevational view of an alternative boom assembly for the camera-based system illustrated in FIG. 1; and

FIG. 9 is an isometric view of an alternative embodiment of a camera-based system for capturing images of a target area in accordance with the present invention.

### DETAILED DESCRIPTION OF THE PREFERRED EMBODIMENTS

The present invention relates generally to a camera-based system for capturing images of a target area. Images of the target area are captured by one or more digital cameras after information has been recorded on the target area and raw image data output by the one or more digital cameras is conveyed to a controller over a high speed serial data communications link. The controller processes the raw image data to yield digital image files that are simplified to high contrast coloured pen strokes on a white or empty background. The controller also includes Internet server capabilities allowing the controller to publish the digital image files thereby to make the digital image files accessible to users through Internet browsers.

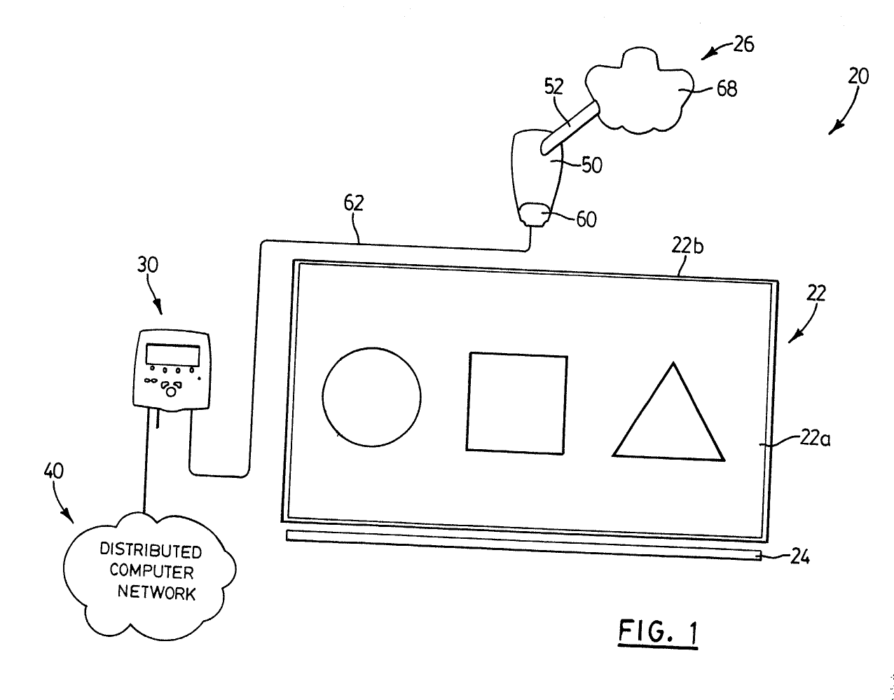

Turning now to FIG. 1, a camera-based system for capturing images of a target area and automatically posting digital images of the target area to an Internet accessible site in accordance with the present invention is shown and is generally identified by reference numeral 20. As can be seen, the system 20 includes a whiteboard 22 mounted on a wall surface. In this embodiment, the whiteboard 22 includes a generally planar rectangular board surface 22a bordered by a frame 22b. An elongate tool tray 24 is disposed slightly below the whiteboard 22 and supports tools in the form of dry-erase ink pens and an eraser. Using the pens and eraser, information can be recorded on the whiteboard 22, as well as edited and erased.

A boom assembly 26 is also mounted on the wall surface slightly above the midpoint of the whiteboard 22. The boom assembly 26 extends outwardly from the wall surface in a generally horizontal disposition a distance equal to about 30 to 50 inches. A controller 30 is also mounted on the wall surface to one side of the whiteboard 22 and communicates with the boom assembly 26 and with a distributed computer network 40.

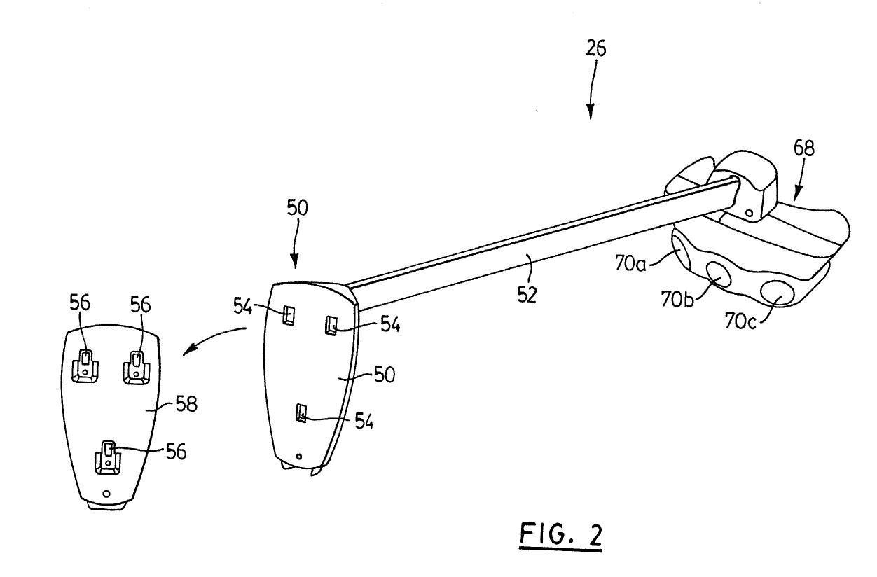

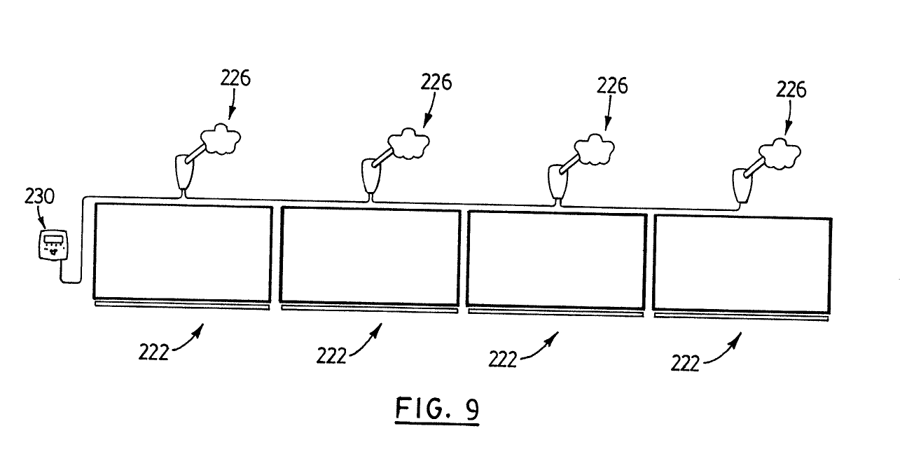

FIG. 2 better illustrates the boom assembly 26 and as can be seen, boom assembly 26 includes a wall mount 50 receiving one end of an elongated boom 52. Wall mount 50 has a plurality of slots 54 formed in its rear surface. The slots 54 releasably receive complimentary tabs 56 on a mounting plate 58 that is secured to the wall surface by suitable fasteners (not shown). The wall mount 50 also includes a pivoting cap 60 that can be moved to expose a pair of plug-in high speed serial data communication ports (not shown). One of the data communication ports receives a cable 62 that extends to the controller 30. The other data communication port is designed to receive a cable leading to the wall mount of an adjacent boom assembly when a number of whiteboards and boom assemblies are chained together as shown in FIG. 9.

A camera head 68 is disposed on the opposite end of the boom 52 and supports three digital cameras 70a to 70c. The digital cameras 70a to 70c are aimed back towards the whiteboard 22, with each digital camera being fitted with an appropriate field-of-view lens so that it captures a different section (tile) of the whiteboard. The field-of-view lenses are however selected so that there is a small overlap in the images captured by adjacent digital cameras. Since the boom assembly 26 is positioned above the whiteboard 22 and is short, a user standing in front of the whiteboard typically remains outside of the fields of view of the digital cameras 70a to 70c. As a result, the digital cameras 70a to 70c typically have an unobscured view of the whiteboard 22.

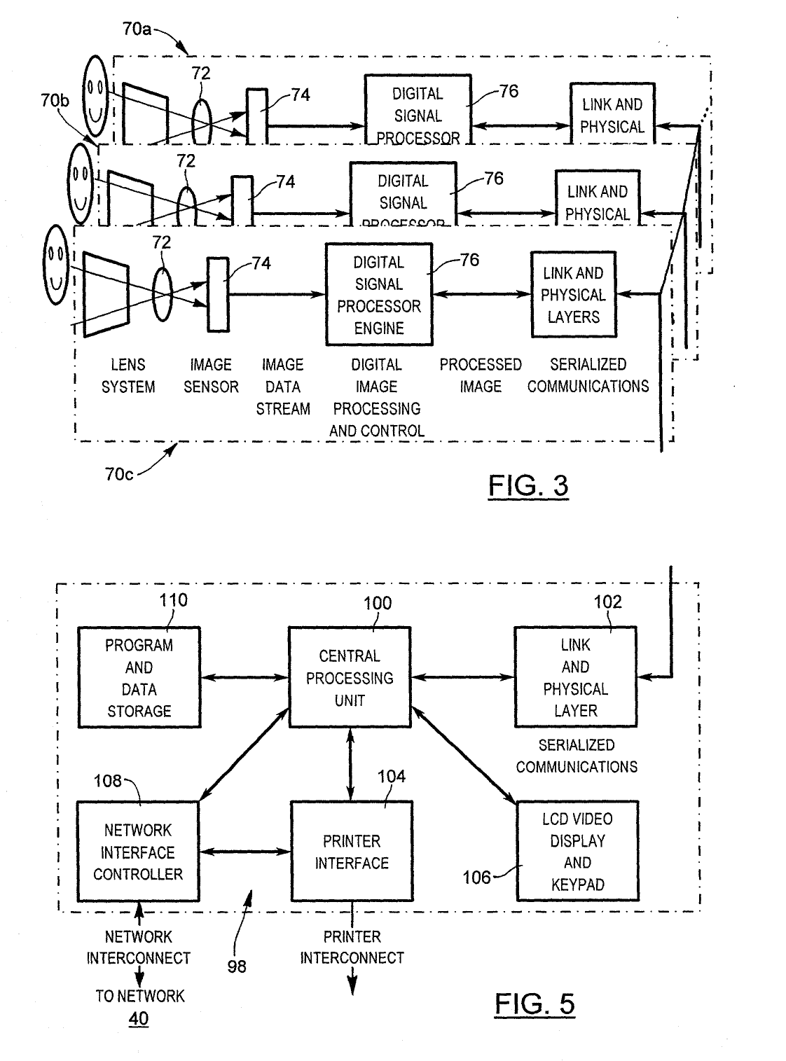

Turning now to FIG. 3 the digital cameras 70a to 70c within the camera head 68 are shown. As can be seen, each digital camera includes a lens system 72 and an image sensor 74. A digital signal processor (DSP) engine 76 is connected to the image sensor 74 and to the high-speed serial data communication ports by cables (not shown) running through the boom 52.

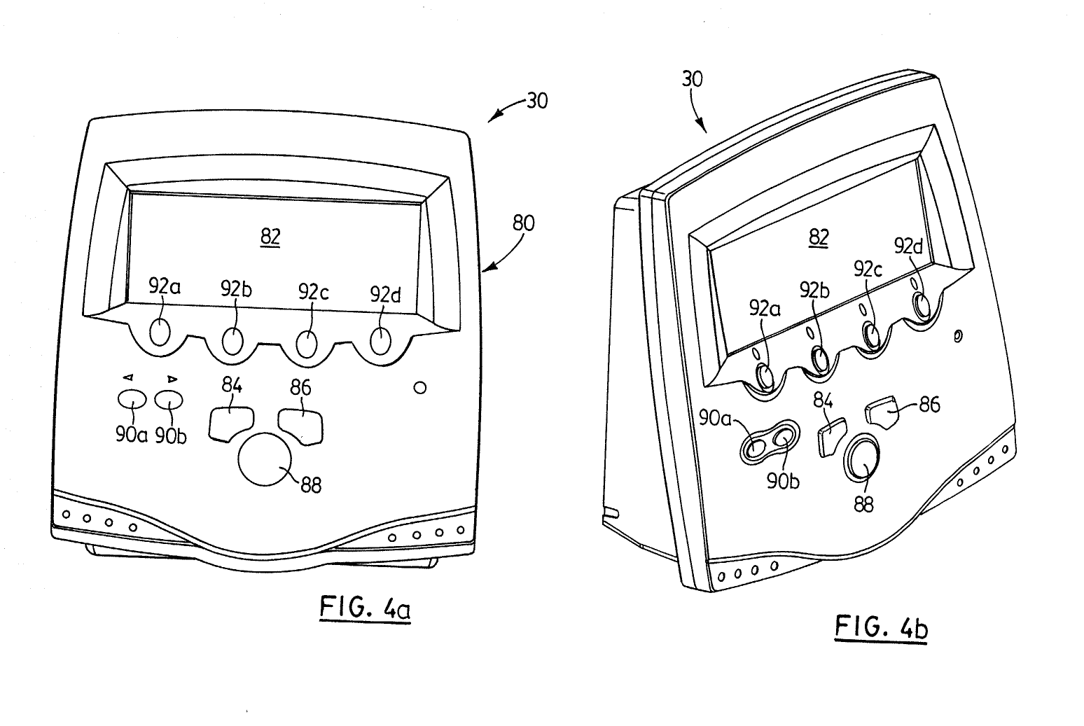

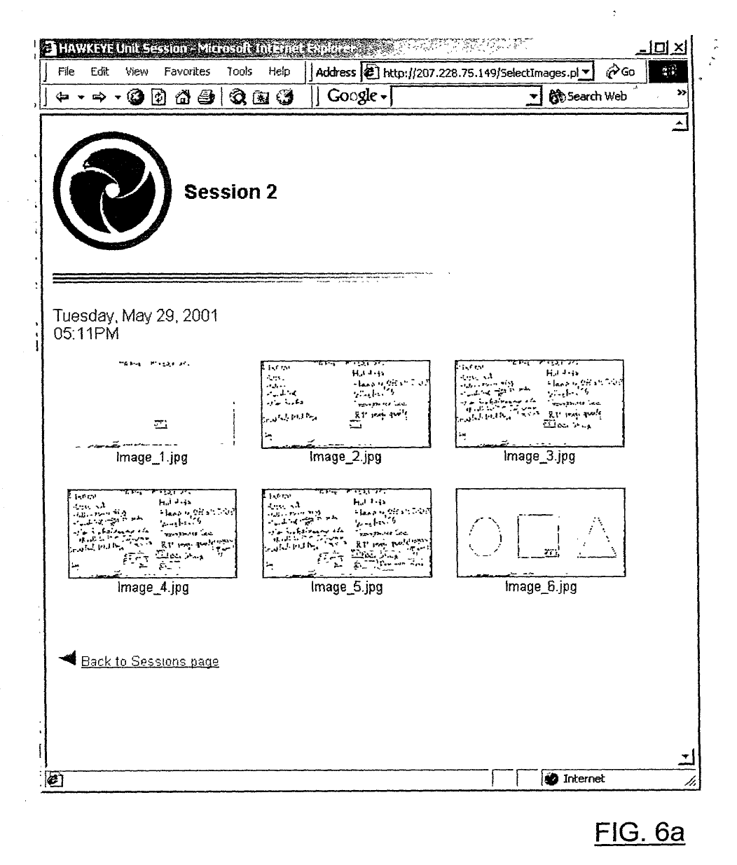

Turning now to FIGS. 4a to 4b, the controller 30 is better illustrated. As can be seen, controller 30 includes a housing 80 having a liquid crystal display screen 82 and a series of user selectable controls in the form of depressable buttons. In this particular embodiment, the buttons include a session open button 84, a session close button 86 and a capture image button 88. A pair of scroll buttons 90a and 90b allow a user to scroll through features presented on the display screen 82. Buttons 92a to 92d allow features presented on the display screen 82 to be selected.

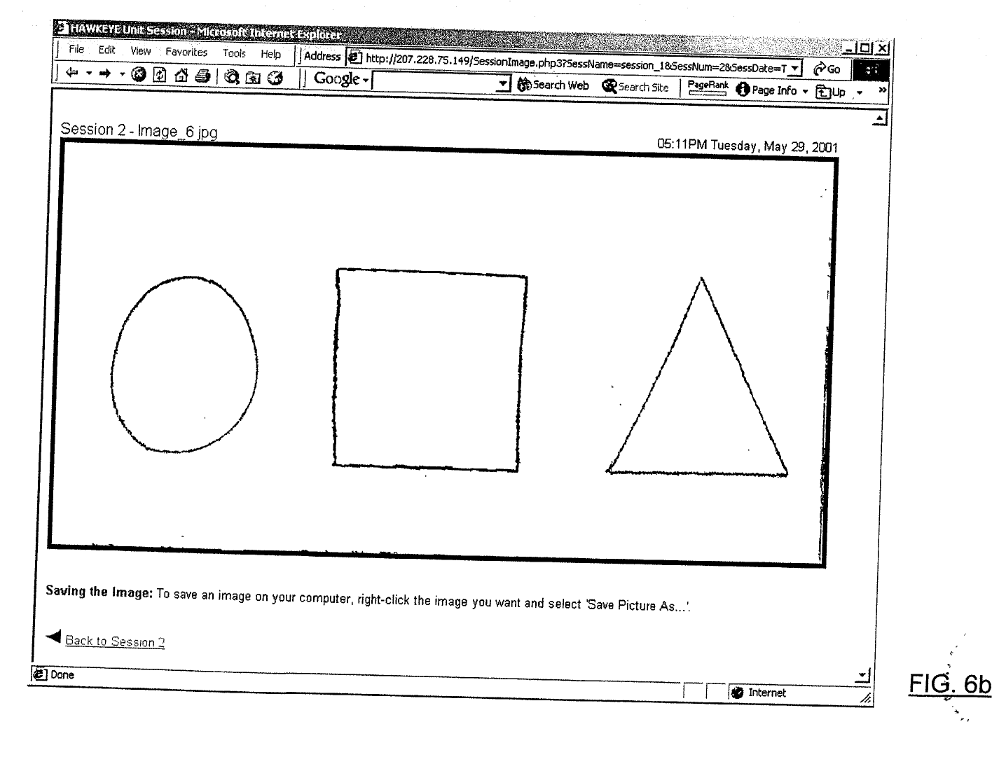

FIG. 5 illustrates the internal circuitry 98 within the housing 80. As can be seen, the internal circuitry 98 includes a central processing unit (CPU) 100 communicating with a high speed serial data communication port 102, a printer interface 104, an LCD video display and a keypad driver 106, a network interface controller 108 and memory 110. High-speed data communication port 102 receives the cable 62 leading to the wall mount 50 of the boom assembly 26. LCD video display and keypad driver 106 drives the display screen 82 and the buttons 84 to 92d. Printer driver 104 is coupled to a port accessible through the housing 80 that is designed to receive a cable extending to an external printer. Printer driver 104 is also coupled to the network interface controller 108.

The central processing unit 100 includes Internet server capabilities and executes software loaded in the memory 110 so that image data output by the digital cameras 70a and 70c can be processed, converted into digital images in JPEG format and made accessible to users through the distributed computer network 40. In this manner, users can access the digital images through web client applications such as web browsers. Further specifics concerning the operation of the system 20 will now be described.

Using the system 20 is very simple regardless of the technical skill level of the user. The controller 30 does not need to be operational prior to drawing or writing on the surface 22a of the whiteboard 22. Once information is recorded on the surface 22a of the whiteboard 22, images of the recorded information can be acquired provided a session is open. If a session is not open, the user must press the session open button 84 to open a session. When the session open button is pressed, the CPU 100 creates a session so that all images captured within the open session are stored collectively. With a session open, in order to capture images, the user simply needs to press the capture image button 88. When the capture image button 88 is pressed, the CPU 100 signals each digital camera causing each digital camera to capture an image of the section of the whiteboard 22 within its field of view. As mentioned previously, because the boom assembly 26 is short and is positioned close to the whiteboard 22 and slightly above it, the user recording information on the whiteboard is rarely in the fields of view of the digital cameras. As such, the user typically does not need to move away from the whiteboard when images of the whiteboard 22 are being acquired by the digital cameras 70a to 70c.

During imaging, the DSP engine 76 of each digital camera acquires raw image data from the image sensor 74 and conveys the raw image data to the CPU 100 over a high speed data communications link via the cable 62. When the CPU 100 receives the raw image data, the CPU converts the raw image data into electronic colour images of the whiteboard sections and then stitches the electronic images together to form an electronic image of the entire whiteboard 22. The manner by which the electronic images are stitched to form a complete image of the whiteboard is disclosed in U.S. Pat. No. 5,528,290 to Saund. Once the electronic image is generated, the CPU 100 further processes the complete image to remove background shades of white created in various lighting conditions so that only high contrast colour pen strokes on a white or empty background remain in the electronic image. This ensures the size of the digital image remains manageable. The CPU 100 then saves the digital image in a desired format, in this embodiment .JPEG format.

With the electronic image processed as above, the CPU 100 also conditions the LCD video display and keyboard driver 106 to present the electronic image on the display screen 82 to provide quick visual feedback to the user. A copy of the digital image may also be sent to a designated secondary storage location such as a personal computer forming part of the distributed computer network 40.

If desired, a user can select a print command using the option buttons on the housing 80. When the CPU 100 receives a print command, the CPU 100 outputs the electronic image to the printer driver 104 which in turn outputs the electronic image either to a printer coupled to the printer driver port or to the network interface controller 108 so that the electronic image can be printed by a network printer in the distributed computer network 40.

When the user is finished a session, the user simply needs to push the close session button 86. If the user wishes to continue using the system 20, a new session must be opened by pushing the open session button 84. Images captured during the new session are saved and posted separately.

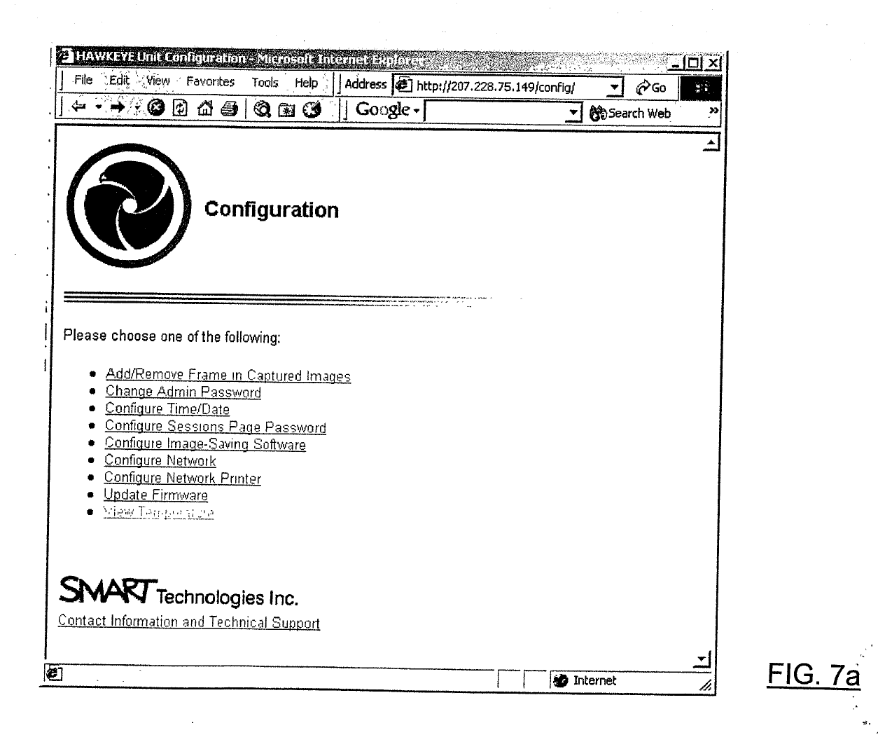

When a user accesses the controller 30 through a web client application such as a web browser executing on a personal computer, links to various sessions created by the controller 30 are presented within a browser window. Selecting a session allows the user to view thumbnails of all of the digital images captured during the session as shown in FIG. 6a. Each thumbnail image can be selected and presented individually in a browser window as shown in FIG. 6b.

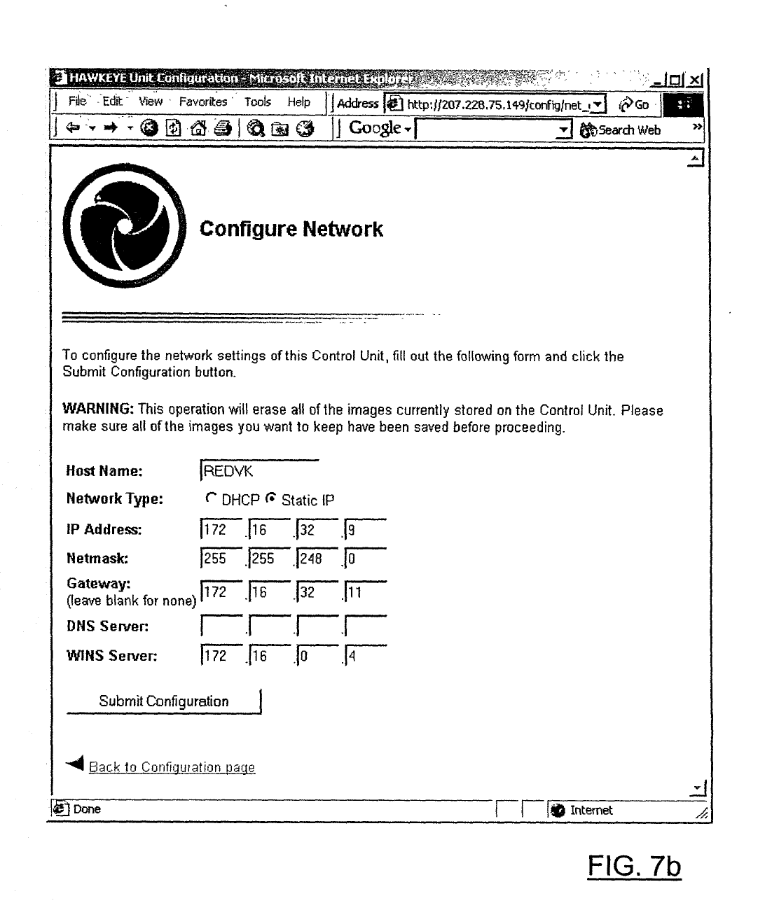

Through the web browser, a user can also configure the system. As can be seen in FIG. 7a, a number of options displayed as links to underlying pages are available to the user allowing the user to add or remove frames in captured images, configure administration and session passwords, configure time and date particulars, configure network printers, configure the image-saving software to enable copies of the digital images to be stored at a designated secondary storage site such as a personal computer in the distributed computer network 40 and to configure the network. Selecting the configure network option opens a page that allows the IP address of the controller 30 to be modified (see FIG. 7b).

The options available to the user through the web browser to configure the system are also available through the controller 30. These options can be displayed on the display screen 82 and selected using the scroll and option buttons on the housing 80.

Although the controller 30 is described as being a wall mounted device, a personal computer executing appropriate software may be used to interface the digital cameras and the distributed computer network 40. Also, although the camera-based system is described with reference to a whiteboard, those of skill in the art will appreciate that the digital cameras can capture information recorded on virtually any target surface such as for example, chalkboards, flipchart pads and tackboards.

As will be appreciated, the camera-based system 20 provides a “walk up and use” interface that requires minimal or no training to enable electronic capture, storage, distribution, electronic publishing or printing of whiteboard, chalkboard, flipchart and tack board information. The mounting plate 28 and wall mount design allows the boom assembly to be easily installed on the wall surface and facilitates the temporary removal of the boom assembly when necessary to accommodate pull-down screens or to transport the boom assembly to a different location.

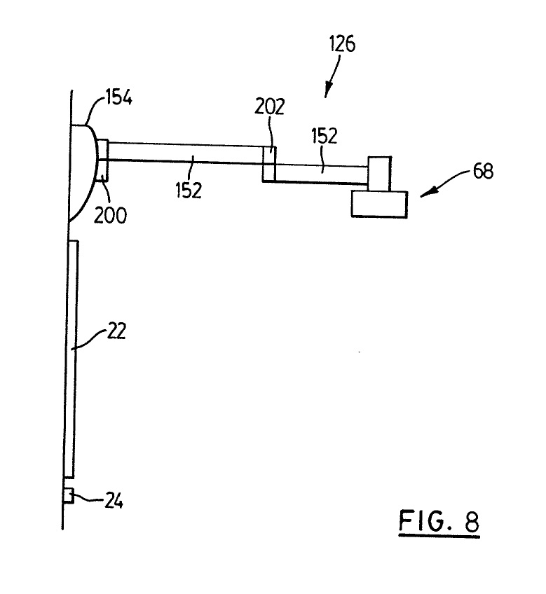

Turning now to FIG. 8, an alternative boom assembly 126 for the camera-based system 20 is shown. In this embodiment, the boom assembly 126 is articulated. As can be seen, the boom 152 is coupled to the wall mount 154 via a hinge 200 and also includes a second hinge 202 intermediate its ends. The hinges 200 and 202 allow the boom 152 to pivot in a horizontal plane about a generally vertical axis. This of course allows the boom 152 to be moved from an extended elongate orientation to a retracted condition where the boom 152 is folded over itself and lies against the wall surface. This of course accommodates pull-down screens without requiring removal of the boom assembly from the wall surface. Folding of the boom 152 in this manner prior to shipping also facilitates transportation. Preferably the hinges 200 and 202 include locking mechanisms to maintain the boom in the extended elongate orientation. The locking mechanisms may include detents on the hinges or locking pins that move into position to inhibit pivoting of the hinges once the boom assumes the elongate orientation.

Turning now to FIG. 9, another embodiment of a camera-based system for capturing images of a target area in accordance with the present invention is shown and is generally identified by reference numeral 220. In this embodiment, the camera-based system includes a plurality of whiteboards 222 and boom, assemblies 226 arranged in series. Similar to the first embodiment, the controller 230 receives image data from the digital cameras on each boom assembly and processes and stitches the image data to generate a digital image of the entire whiteboard surfaces.

Although the camera-based system is described as having three digital cameras on the camera head disposed at the end of the boom, those of skill in the art will appreciate that depending on the size of the board different numbers of digital cameras may be used. For example, the camera head may include a pair of digital cameras or a single digital camera. If a single digital camera is used and the size of the board is significant, the digital camera can be pivotally mounted within the camera head so that it sweeps in an arc under software control in order to acquire images of the entire board.

Although preferred embodiments of the present invention have been described, those of skill in the art will appreciate that variations and modifications may be made without departing from the spirit and scope thereof as defined by the appended claims.

What is claimed is:

1. A camera-based system for capturing images of a target area comprising:
a generally horizontally extending boom assembly, said boom assembly being positioned above a target area;
at least one digital camera mounted on said boom assembly at a location spaced from the plane of said target area, said at least one digital camera being oriented so that the field of view thereof encompasses said target area; and
a controller in communication with said at least one digital camera, said controller receiving image data from said at least one digital camera and processing said image data to form a digital image of said target area.

2. A system according to claim 1 wherein said boom assembly is positioned above the midpoint of said target area.

3. A system according to claim 2 wherein said boom assembly has a length of from about 30 to 50 inches.

4. A system according to claim 3 wherein said boom assembly includes a wall mount, a boom extending outwardly from said wall mount and a camera head on a distal end of said boom, said camera head supporting said at least one digital camera.

5. A system according to claim 4 wherein said wall mount is releasably coupled to a wall plate secured to a wall surface.

6. A system according to claim 4 wherein said boom assembly is articulated and is moveable between an extended operating position and a folded retracted condition.

7. A system according to claim 6 wherein said boom assembly includes a pair of hinges at spaced locations along said boom to enable said boom to fold over itself.

8. A system according to claim 7 wherein each of said hinges includes a locking mechanism to retain said boom assembly in said extended operating position.

9. A system according to claim 4 wherein said camera head supports a plurality of digital cameras, each of said digital cameras having a field of view that encompasses a distinct section of said target area, fields of view of adjacent digital cameras overlapping slightly.

10. A system according to claim 9 wherein said camera head supports a pair of digital cameras.

11. A system according to claim 9 wherein said camera head supports three digital cameras.

12. A system according to claim 9 wherein said camera head supports a single digital camera.

13. A system according to claim 12 wherein said digital camera appliance is pivotally mounted on said camera head and is moveable about an arc to capture images of distinct sections of said target area, images of adjacent distinct sections of said target overlapping.

14. A system according to claim 1 wherein said controller is coupled to a computer network and uses resources of said computer network.

15. A system according to claim 14 wherein said controller uses storage, printing, distribution and/or remote viewing resources of said computer network.

16. A system according to claim 2 wherein said controller has Internet server capabilities and is coupled to a distributed computer network to allow said digital image to be accessed by a user through an Internet browser.

17. A system according to claim 16 wherein said controller is a dedicated appliance.

18. A system according to claim 16 wherein said controller is a personal computer.

19. A system according to claim 16 wherein said controller sends said digital image to a designated secondary storage location in said distributed computer network.

20. A system according to claim 16 wherein said controller includes a display to present the digital image.

21. A system according to claim 16 wherein said controller processes image data received from said at least one digital camera to yield high contrast pen strokes on a white or empty background.

22. A system according to claim 21 wherein said pen strokes are in colour.

23. A camera-based system for capturing images of a target area comprising:
a boom assembly adapted to extend outwardly from a generally vertical surface;
at least one digital camera mounted on said boom assembly at a location spaced from said surface, said at least one digital camera being oriented so that the field of view thereof encompasses said target area; and
a controller in communication with said at least one digital camera, said controller conditioning said at least one digital camera to acquire an image of said target area, said image acquired by said at least one digital camera being conveyed to said controller and processed to form a digital image of said target area, said digital image being accessible to a user through a web client application.

24. A system according to claim 23 wherein said controller automatically publishes said digital image.

25. A system according to claim 24 wherein said controller also sends said digital image to a designated secondary storage location.

26. A system according to claim 24 wherein said controller processes image data received from said at least one digital camera to reduce the size of said digital image.

27. A system according to claim 26 wherein said image data is processed to yield high contrast pen strokes on a white or empty background.

28. A system according to claim 27 wherein said controller saves said digital image in a selected format.

29. A system according to claim 28 wherein said selected format is a .JPEG format.

30. A system according to claim 27 wherein said controller includes a display to present the digital image.

31. A system according to claim 23 wherein said boom assembly includes a wall mount, a boom extending outwardly from said wall mount and a camera head on a distal end of said boom, said camera head supporting said at least one digital camera.

32. A system according to claim 31 wherein said wall mount is releasably coupled to a wall plate secured to said surface.

33. A system according to claim 31 wherein said boom assembly is articulated and moveable between an extended operating position and a folded retracted condition.

34. A system according to claim 33 wherein said boom assembly includes a pair of hinges at spaced locations along said boom to enable said boom to fold over itself.

35. A system according to claim 34 wherein each of said hinges includes a locking mechanism to retain said boom assembly in said extended operating position.

36. A system according to claim 31 wherein said camera head supports a plurality of digital cameras, each of said digital cameras having a field of view that encompasses a distinct section of said target area, fields of view of adjacent digital cameras overlapping slightly.

37. A system according to claim 36 wherein said camera head supports a pair of digital cameras.

38. A system according to claim 36 wherein said camera head supports three digital cameras.

39. A system according to claim 36 wherein said camera head supports a single digital camera.

40. A system according to claim 39 wherein said digital camera is pivotally mounted on said camera head and is moveable about an arc to capture images of distinct sections of said target area, images of adjacent distinct sections of said target overlapping.

41. A system according to claim 31 wherein said boom assembly has a length of from about 30 to 50 inches.

42. A camera-based system for capturing images of a target surface comprising:
a board mounted on a wall and having a surface on which information is to be recorded;
a boom assembly positioned above said board and extending outwardly from said wall in a generally horizontal disposition;
at least one digital camera mounted on said boom assembly at a location spaced from said wall, said at least one digital camera being oriented so that the field of view thereof encompasses a target area of said surface; and
a controller in communication with said at least one digital camera and having Internet server capabilities, said controller being responsive to user input and conditioning said at least one digital camera to acquire an image of said target area, said image acquired by said at least one digital camera being conveyed to said controller and processed to form an electronic image of said target area, said electronic image being published automatically to allow said electronic image to be accessed by a user through a web client application.

43. A system according to claim 42 wherein said target area corresponds to said surface.

44. A system according to claim 43 wherein said controller also sends said electronic image to a designated secondary storage location.

45. A system according to claim 44 wherein said controller processes image data received from said at least one digital camera to reduce the size of said digital image.

46. A system according to claim 45 wherein said image data is processed to yield high contrast pen strokes on a white or empty background.

47. A system according to claim 46 wherein said controller saves said electronic image in a selected format.

48. A system according to claim 47 wherein said controller includes a display to present the electronic image.

49. A system according to claim 42 wherein said boom assembly includes a wall mount, a boom extending outwardly from said wall mount and a camera head on a distal end of said boom, said camera head supporting said at least one digital camera appliance.

50. A system according to claim 49 wherein said boom assembly has a length of from about 30 to 50 inches.

51. An image publication and distribution method comprising the steps of:
acquiring an image of a target area that includes information recorded on said target area;
processing said image to form an electronic black on white image of the information recorded on said target area; and
automatically publishing said electronic image to allow said electronic image to be accessed by a user through a web client application.

52. The method of claim 51 further comprising the step of forwarding said electronic image to a secondary location for storage.

53. The method of claim 51 wherein during said processing said image data is processed to yield high contrast pen strokes on a white or empty background.

54. The method of claim 53 further comprising the step of presenting said electronic image on a display device while said electronic image is being posted.

55. The method of claim 53 wherein said high contrast pen strokes are in colour.
